(19) United States
(12) Patent Application Publication
(10) Pub. No.: US 2025/0198915 A1
(43) Pub. Date: Jun. 19, 2025

(54) SPECTRAL FEATURE MEASUREMENT METHOD

(71) Applicant: Industrial Technology Research Institute, Hsinchu (TW)

(72) Inventors: Yan-Rung Lin, Hsinchu City (TW); Chia-Liang Yeh, Hsinchu County (TW); Shau-Wei Hsu, Hsinchu County (TW); Hsiang-Chun Wei, Hsinchu City (TW)

(73) Assignee: Industrial Technology Research Institute, Hsinchu (TW)

(21) Appl. No.: 18/985,050

(22) Filed: Dec. 18, 2024

Related U.S. Application Data
(60) Provisional application No. 63/611,778, filed on Dec. 19, 2023.

(30) Foreign Application Priority Data
Dec. 6, 2024 (TW) 113147564

(51) Int. Cl. G01N 21/31; G01N 21/88

(52) U.S. Cl. CPC G01N 21/314; G01N 21/8851

(57) ABSTRACT

A spectral feature measurement method includes: multiple points to be measured on an object to be measured are measured with a spectrum measurement device to obtain multiple filtered signal groups of multiple spectra to be measured emitted by the points to be measured; and spectral features of the spectra to be measured are calculated based on the filtered signal groups and an algorithm, in which the algorithm is generated by multiple reference spectra, multiple reference filter signal groups of the reference spectra, and the spectral features, and similarity between the reference spectra and the spectra to be measured is greater than a similarity threshold.

### CROSS-REFERENCE TO RELATED APPLICATION

This application claims the priority benefits of U.S. provisional application Ser. No. 63/611,778, filed on Dec. 19, 2023, and Taiwan application serial no. 113147564, filed on Dec. 6, 2024. The entirety of each of the above-mentioned patent applications is hereby incorporated by reference herein and made a part of this specification.

### TECHNICAL FIELD

The disclosure relates to a spectral feature measurement method.

### BACKGROUND

In semiconductor manufacturing processes, some semiconductor components on wafers may develop defects. Therefore, how to rapidly detect the positions and quantities of defective semiconductor components on wafers has become a crucial step in evaluating semiconductor yield or controlling product quality in backend processes.

Spectrum measurement has a wide range of applications in non-destructive detection, and may be used to reveal material composition. When applied to semiconductor components, spectrum measurement may disclose material properties, component properties, and monitor process parameters. Therefore, measuring the spectrum emitted by semiconductor components is a common non-destructive detection means for detecting semiconductor components. However, measuring the spectrum requires a relatively long time, thereby being unsuitable for large-scale detection.

### SUMMARY

The disclosure provides a spectral feature measurement method to rapidly obtain spectral features.

A spectral feature measurement method of the disclosure includes: multiple points to be measured on an object to be measured are measured with a spectrum measurement device to obtain multiple filtered signal groups of multiple spectra to be measured emitted by the points to be measured; and spectral features of the spectra to be measured are calculated based on the filtered signal groups and an algorithm, in which the algorithm is generated by multiple reference spectra, multiple reference filter signal groups of the reference spectra, and the spectral features, and similarity between the reference spectra and the spectra to be measured is greater than a similarity threshold.

Based on the above, the rapid spectral feature measurement method provided by the disclosure uses a camera with an optical filter set to quickly measure multi-point spectra on a wafer, combined with a process and correction technique, balancing accuracy and speed. Moreover, spectral features may be obtained without fully scanning the spectrum, which may effectively reduce detection costs and improve detection efficiency.

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### BRIEF DESCRIPTION OF THE DRAWINGS

The accompanying drawings are included to provide a further understanding, and are incorporated in and constitute a part of this specification. The drawings illustrate exemplary embodiments and, together with the description, serve to explain the principles of the disclosure.

FIGS. 1A and 1B are schematic diagrams of a spectrum measurement device according to an embodiment of the disclosure.

FIG. 2 is a spectrum of the object to be measured according to an embodiment of the disclosure.

FIGS. 3A to 3D are schematic diagrams of spectrum dissimilarity of the object to be measured according to an embodiment of the disclosure.

FIG. 4A is a schematic diagram of an optical filter set and light sensors according to an embodiment of the disclosure.

FIG. 4B is a schematic diagram illustrating the operation of an optical filter set according to an embodiment of the disclosure.

FIG. 5 is a schematic diagram of an optical filter set and light sensors according to an embodiment of the disclosure.

FIG. 6A is a schematic diagram of an optical filter set and light sensors according to an embodiment of the disclosure.

FIG. 6B is a schematic diagram of a spectrum obtained by an optical filter set and light sensors according to an embodiment of the disclosure.

FIG. 7 is a flow chart of a spectral feature measurement method according to an embodiment of the disclosure.

FIGS. 8A and 8B are clustering diagrams of a machine learning method according to an embodiment of the disclosure.

FIG. 9 is a schematic diagram of spectra of defect images of an object to be measured according to an embodiment of the disclosure.

FIG. 10 is a flow chart of another spectral feature measurement method according to an embodiment of the disclosure.

FIG. 11 is a flow chart of another spectral feature measurement method according to an embodiment of the disclosure.

FIGS. 12A to 12C are schematic diagrams of spectra of defects on the object to be measured according to an embodiment of the disclosure.

FIG. 13 is a schematic diagram of spectrum dissimilarity of defect images of the object to be measured according to an embodiment of the disclosure.

### DETAILED DESCRIPTION OF DISCLOSURED EMBODIMENTS

Analyzing the state of semiconductor components based on the spectrum emitted by the semiconductor components is a common non-destructive detection method. However, performing large-area spectrum measurement on semiconductor components on a wafer requires a considerable amount of time. Therefore, the disclosure provides a method for extracting spectral features by measuring a portion of the spectrum.

The following embodiments are described in detail with reference to the accompanying drawings, but the provided embodiments are not intended to limit the scope covered by the disclosure. Furthermore, the dimensions of elements in the drawings are drawn for convenience of description and do not represent the actual proportions of the elements. Moreover, although terms such as “first,” “second,” etc. are used to describe different elements and/or layers in the text, these elements and/or layers should not be limited by these terms. Instead, these terms are merely used to distinguish one element or layer from another element or layer. Therefore, a first element or layer discussed below may be referred to as a second element or layer without departing from the teachings of the embodiment. In order to facilitate understanding, similar elements in the following text are described with the same symbols.

In the description of embodiments of the disclosure, different examples may use repeated reference symbols and/or words. These repeated symbols or words are used for the purposes of simplification and clarity, and are not intended to define the relationships between the various embodiments and/or described appearance structures. Moreover, if the following content of the disclosure in the specification describes forming a first feature on or above a second feature, it includes embodiments in which the formed first feature is in direct contact with the second feature, as well as embodiments in which additional features are formed between the first feature and the second feature, such that the first feature and the second feature may not be in direct contact. In order to facilitate understanding, similar elements in the following text are described with the same symbols.

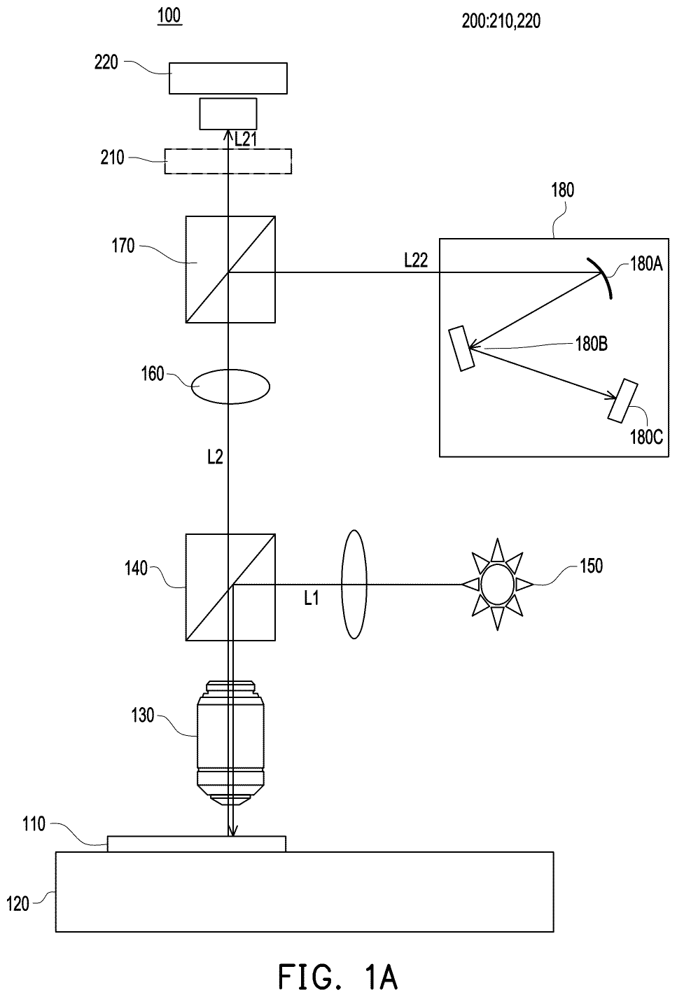

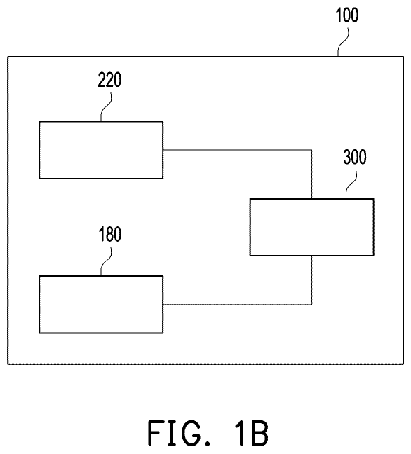

FIGS. 1A and 1B are schematic diagrams of a spectrum measurement device according to an embodiment of the disclosure.

Referring to FIG. 1A, a spectrum measurement device 100 includes: an XY platform 120, used to carry an object to be measured 110, and move along the X direction or Y direction in a horizontal plane. In some embodiments, the object to be measured 110 may be multiple points on a patterned or unpatterned semiconductor or compound semiconductor component, epitaxial layer, or substrate. In some embodiments, the object to be measured 110 may be multiple points on a substrate or on a semiconductor layer/compound semiconductor layer on a substrate, or each of components thereon. In some embodiments, the object to be measured 110 may be multiple diode components (such as LED components, diodes, or multiple metal-oxide-semiconductor field-effect transistors) on a substrate/carrier, or points on a compound semiconductor substrate or epitaxial layer (defects on a compound semiconductor substrate/epitaxy, such as stacking faults (SF) in SiC). However, the disclosure is not limited thereto.

To detect the spectra of multiple points to be measured on the object to be measured 110, the points to be measured emit multiple spectra to be measured by electroluminescence or photoluminescence. FIG. 1A shows an embodiment for measuring photoluminescence, which may also be modified by removing an excitation light source 150, a lens, and a beam splitter (or dichroic mirror) 140, and instead applying electricity to the object to be measured to generate a spectrum to be measured through electroluminescence.

Electroluminescence involves applying electricity to the point to be measured on the object to be measured 110 to make the point to be measured emit light. The method is suitable for detecting light-emitting semiconductor components, such as micro LEDs. The method may also be used to detect compound semiconductor components, by applying electricity to the compound semiconductor components to make defects thereof emit light.

Photoluminescence involves irradiating a point to be measured on the object to be measured 110 with an excitation beam to excite the point to be measured and make the point to be measured emit light. By generating different spectral beams after the point to be measured is excited, the state of the point to be measured may be known. For example, in FIG. 1A, an excitation spectrum L1 is emitted from the excitation light source 150, refracted by the beam splitter (or dichroic mirror) 140, passes through an objective lens 130, and irradiates the point to be measured on the object to be measured 110.

After the points to be measured on the object to be measured 110 emit multiple spectra to be measured L2 by electroluminescence or photoluminescence, the spectra to be measured L2 pass through the objective lens 130, the beam splitter (or dichroic mirror) 140, and a lens 160 along the optical path in sequence, before being incident on a beam splitter 170. When the spectrum to be measured L2 is generated by photoluminescence from the object to be measured 110, the spectrum to be measured L2 may first pass through an optical filter (not shown in the figure) before being incident on the beam splitter 170. The optical filter is configured before the beam splitter 170, for example, between the lens 160 and the beam splitter 170, to filter out components from the excitation spectrum L1 in the spectrum to be measured L2, leaving merely the spectrum generated by photoluminescence from the object to be measured 110. When the spectrum to be measured L2 is generated by electroluminescence from the object to be measured 110, the spectrum to be measured L2 does not contain components from the excitation spectrum L1, the spectrum to be measured L2 does not need to pass through an optical filter for removing the excitation spectrum L1 before being incident on the beam splitter 170.

In the embodiment, the spectrum to be measured L2 is divided into two parts L21 and L22 by the beam splitter 170. The first part L21 of the spectrum to be measured L2 passes through the beam splitter 170 and enters a measurement module 200. The measurement module 200 includes an optical filter set 210 and at least one light sensor 220. Multiple spectra to be measured L2 emitted from multiple points to be measured pass through the optical filter set 210 and are incident on the light sensor 220. After detection by the light sensor 220, multiple filtered signal groups are obtained.

Therefore, as shown in FIG. 1A, the spectrum measurement device 100 may use the measurement module 200 to measure the filtered signal group of the spectrum to be measured L2, which merely includes partial information of the spectrum to be measured L2. On the other hand, the spectrum measurement device may use a spectrometer 180 to measure the complete spectrum of the spectrum to be measured L2 as a reference spectrum.

In FIG. 1A, the objective lens 130, lens 160, and other optical elements may be changed, added, or reduced according to actual requirements. The disclosure is not limited thereto.

Referring to FIG. 1B, the spectrum measurement device 100 further includes a processor 300. The processor 300 is electrically connected to the light sensor 220 and the spectrometer 180. The filtered signal group of the spectrum to be measured L2 measured by the light sensor 220, and the spectrum to be measured L2 measured by the spectrometer 180, may be transmitted to the processor 300 for processing to obtain the spectral features of the spectrum to be measured. In the embodiment, the spectral features include: a peak wavelength, a dominant wavelength, total spectral intensity, full width at half maximum, color purity, or chromaticity coordinates, but are not limited thereto.

In some embodiments, the processor 300 includes a central processing unit (CPU) for processing data and computer-readable instructions, and memory for storing data and instructions. The memory may include volatile random access memory (RAM), non-volatile read-only memory (ROM), and/or other types of memory. The memory may also include a data storage component for storing data and controller/processor executable instructions. The data storage component may include one or more non-volatile solid-state storage devices (such as flash memory, read-only memory (ROM), magnetoresistive RAM (MRAM), ferroelectric RAM (FRAM), phase-change memory, etc.), but the disclosure is not limited thereto.

Specifically, each of semiconductor components on the object to be measured may obtain at least two filtered signals through different filtering methods. For example, in an embodiment, the filtered signal group obtained by the spectrum measurement device 100 in FIG. 1A may include an image obtained by the red optical filter in the optical filter set 210, and an image obtained by the blue optical filter in the optical filter set 210. By using two or more filtered signals, the spectral features of the spectrum to be measured may be obtained, including: a peak wavelength, a dominant wavelength, total spectral intensity, full width at half maximum, color purity, or chromaticity coordinates, but are not limited thereto.

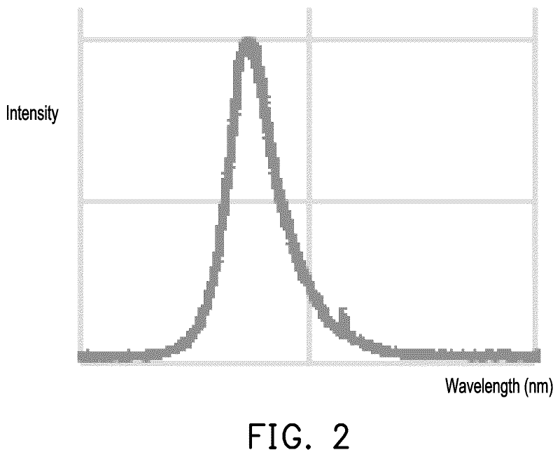

FIG. 2 is a spectrum of the object to be measured according to an embodiment of the disclosure. Specifically, FIG. 2 shows the complete spectrum to be measured of the object to be measured obtained by the spectrometer 180 shown in FIG. 1A. Based on the complete spectrum to be measured, the spectral features of the complete spectrum to be measured can be accurately obtained, including: a peak wavelength, a dominant wavelength, total spectral intensity, full width at half maximum, color purity, or chromaticity coordinates, but are not limited thereto. The spectral features obtained from the complete spectrum to be measured of the object to be measured by the spectrometer may be used to compare with the spectral features calculated from the filtered signal group. Therefore, the complete spectrum to be measured of the object to be measured by the spectrometer 180 is also referred to as a monitor spectrum.

Using the filtered signal group of the spectrum to be measured, which is partial information of the spectrum to be measured, to obtain the spectral features of the spectrum to be measured, this method is suitable for spectra to be measured with high spectrum similarity, that is, the degree of similarity between two spectral curves S1 and S2, with higher values indicating greater similarity. Spectrum dissimilarity (SpD) may also be used to determine, that is, SpD=1−spectrum similarity, and the more similar the two spectra S1 and S2 are, the lower the SpD value.

When the spectrum similarity between two spectra is higher, or the spectrum dissimilarity (SpD) is lower, it indicates that the shapes of the two spectra are quite close. When the object to be measured is a semiconductor component or semiconductor material, whether by electroluminescence or photoluminescence, the spectra emitted by the components or defects possess quite high similarity respectively.

The spectrum dissimilarity (SpD) between the two spectra S1 and S2 is defined as follows:

$$Spectrum dissimilarity SpD ≡ 1 - \vert \frac{cov ( {S}_{1} , {S}_{2} )}{\sqrt{cov ( {S}_{1} , {S}_{1} ) \cdot cov ( {S}_{2} , {S}_{2} )}} \vert , where$$

$$cov ( {S}_{1} , {S}_{2} ) = \frac{1}{N} {\sum }_{i = 0}^{N} [ {S}_{1} ( {λ}_{i} ) - {\overline{S}}_{1} ] \cdot [ {S}_{2} ( {λ}_{i} ) - {\overline{S}}_{2} ] ,$$

where S₁(λᵢ) is the intensity of the spectrum S1 at λᵢ, S̅₁ is the average intensity of the spectrum S1, S₂(λᵢ) is the intensity of the spectrum S2 at λᵢ, S̅₂ is the average intensity of the spectrum S2.

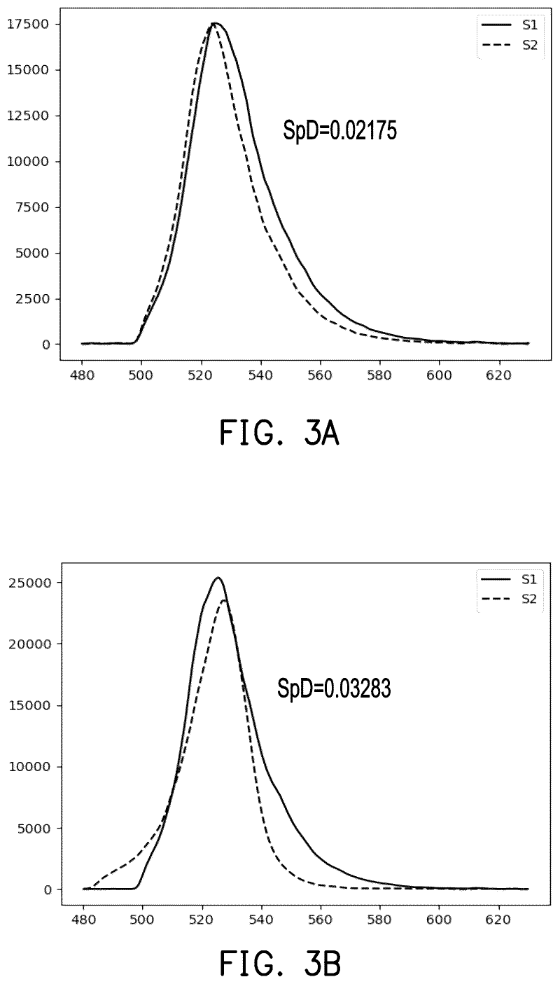

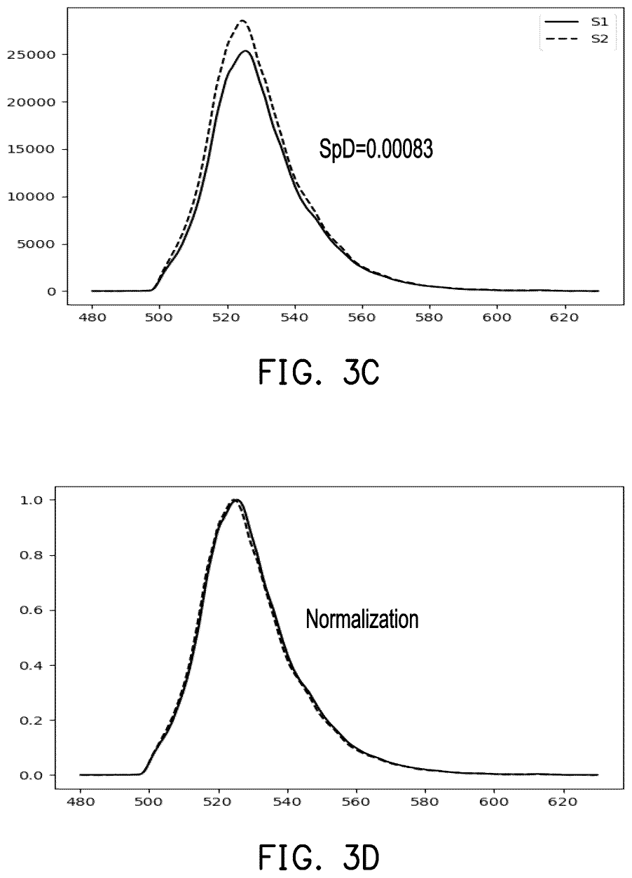

FIGS. 3A to 3D are schematic diagrams of spectrum dissimilarity of the object to be measured according to an embodiment of the disclosure.

In some embodiments, for example, LEDs on a substrate, of which electroluminescence or photoluminescence spectra possess features of high similarity in spectral shape and low dissimilarity.

FIGS. 3A, 3B, and 3C respectively show the dissimilarity between the spectrum and the reference spectrum at three different points to be measured in the same sample. Here, the spectrum S1 is the measurement spectrum, and the spectrum S2 is the standard spectrum. The spectrum dissimilarity shown in FIGS. 3A, 3B, and 3C are 0.02175, 0.03238, and 0.00083, respectively. It may be observed that the measurement spectrum in FIG. 3C is the most similar to the standard spectrum. FIG. 3D shows a comparison of the normalized measurement spectrum S1 and the standard spectrum S2 from FIG. 3C. The two spectra almost completely overlap, which also confirms the spectrum similarity of the two spectra.

In general cases, the standard spectrum may be one of multiple spectra where the full width at half maximum (FWHM) of the spectrum is the mode, median, or close to the average of the FWHMs of multiple spectra. Alternatively, spectra with FWHM distributions near the mode of the FWHM may be selected, normalized, and peaks thereof aligned to the same position. Then, either the average of the spectra or one of the spectra may be taken as the standard spectrum.

As shown in FIG. 1A, the spectrum measurement device 100 obtains multiple filtered signal groups with the measurement module 200 that includes the optical filter set 210 and the at least one light sensor 220. Some embodiments of the measurement module 200 are described below, but are not limited thereto.

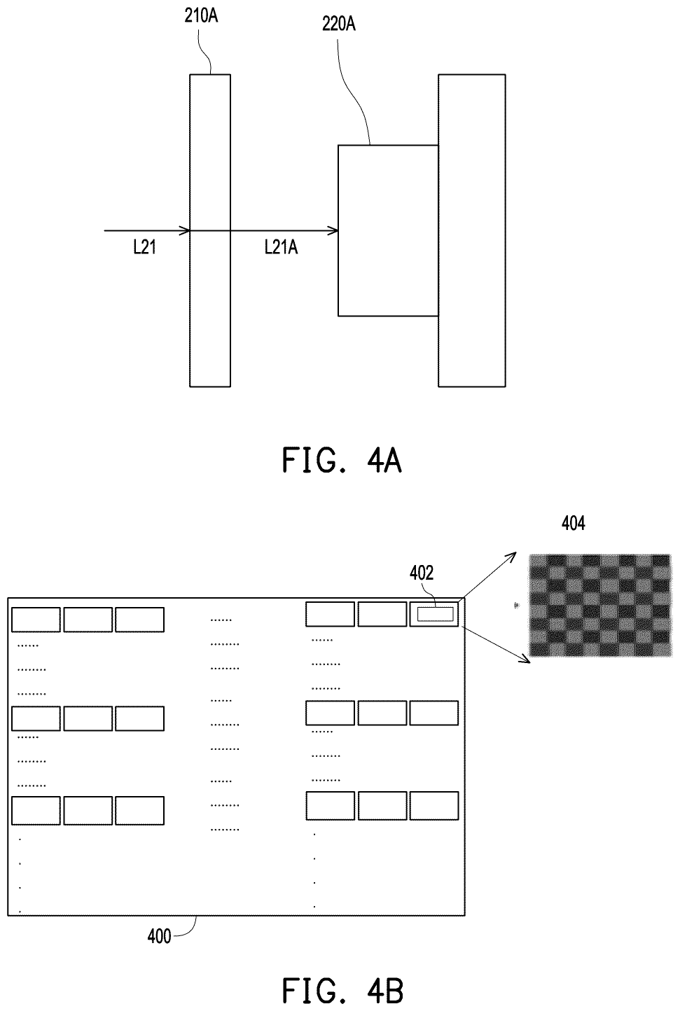

FIG. 4A is a schematic diagram of an optical filter set and a light sensor according to an embodiment of the disclosure. FIG. 4B is a schematic diagram illustrating the operation of an optical filter set according to an embodiment of the disclosure.

FIG. 4A shows an embodiment of the measurement module 200, including an optical filter set 210A and a light sensor 220A. The first part L21 of the spectrum to be measured L2 is incident on the optical filter set 210A, becoming a filtered spectrum L21A that is incident on the light sensor 220A. The optical filter set 210A is an RGB array optical filter, for example, a Bayer filter. The Bayer filter is a mosaic color filter array formed by arranging RGB color filters on top of a light sensor. The light sensor 220A is a single light sensor. In some embodiments, the light sensor 220A may be an optical camera.

When the optical filter set 210A is an RGB array optical filter, as shown in FIG. 4B, taking micro-LEDs as an example, multiple micro-LEDs are covered within a field of view (FOV) 400. A region of interest (ROI) 402 within one micro-LED is defined. An image 404 is the image obtained from the region of interest 402 when the optical filter set 210A is an RGB array optical filter. Therefore, the average of the red pixel signals within the region of interest may be obtained as Ri, the average of the blue pixel signals as Bi, and the average of the green pixel signals as Gi. At this point, the obtained filtered signal group includes three pieces of filtering information (Ri, Gi, Bi).

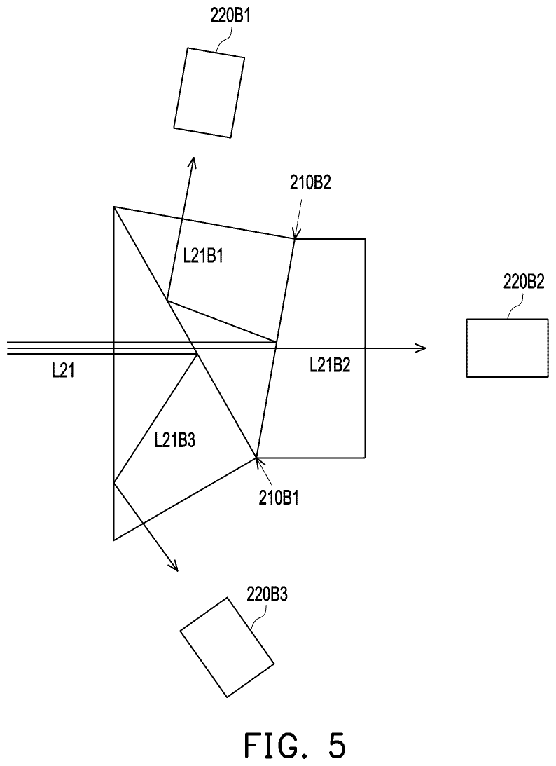

FIG. 5 is a schematic diagram of an optical filter set and light sensors according to an embodiment of the disclosure. As shown in FIG. 5, the optical filter set is a dichroic prism, with three light sensors 220B1, 220B2, and 220B3. When the spectrum to be measured L21 is incident on the dichroic prism, which is an optical filter set 210B, the spectrum to be measured L21 passes through a first optical filter 210B1, causing the blue light portion of the spectrum to be measured L21 to be reflected, becoming a filtered spectrum L21B3 entering the light sensor 220B3. The red light portion of the spectrum to be measured L21 passes through the first optical filter 210B1, then is reflected by a second optical filter 210B2, becoming a green light spectrum L21B1 entering the light sensor 220B1. The green light portion of the spectrum to be measured L21 passes through the first optical filter 210B1, then passes through the second optical filter 210B2, becoming a filtered spectrum L21B2 entering the light sensor 220B2. Therefore, the light sensors 220B1, 220B2, and 220B3 may obtain the red, green, and blue light signals of the spectrum to be measured L21, respectively. At this point, the obtained filtered signal group includes three pieces of filtering information (Ri, Gi, Bi).

The filtering information of the filtered signal group, in addition to the spectral components of red light, green light, and blue light, may also use spectra of different wavelength bands as filtering information.

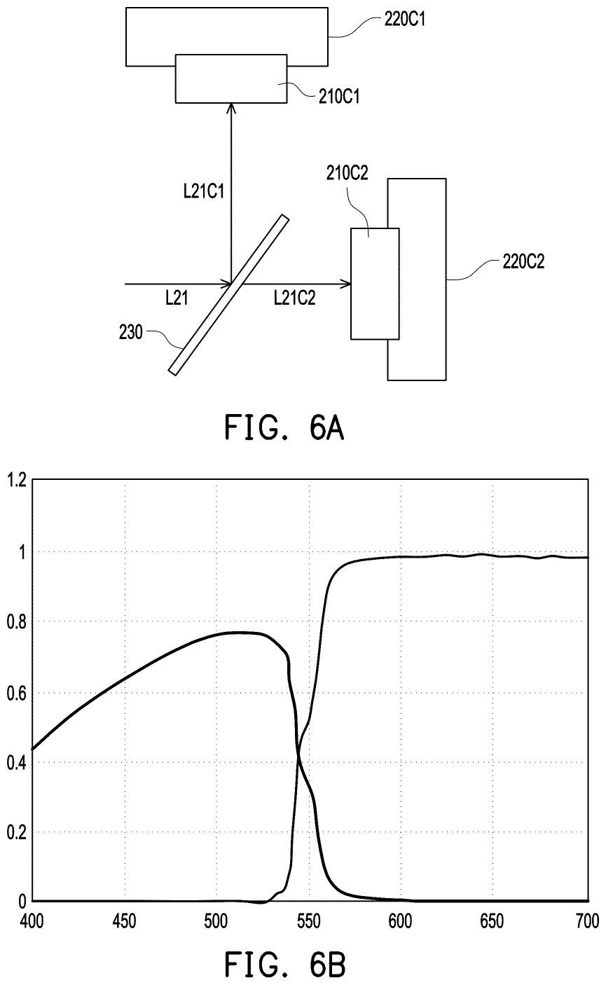

FIG. 6A is a schematic diagram of an optical filter set and light sensors according to an embodiment of the disclosure. In FIG. 6A, the optical filter set includes two optical filters 210C1 and 210C2, and the light sensors include 220C1 and 220C2. The spectrum to be measured L21 is divided into two parts after being incident on a beam splitter (or dichroic mirror) 230. A first part L21C1 of the spectrum to be measured L21 passes through the optical filter 210C1 and is incident on the light sensor 220C1. A second part L21C2 of the spectrum to be measured passes through the optical filter 210C2 and is incident on the light sensor 220C2. In the embodiment, the optical filter 210C1 may be a low-pass optical filter, allowing the shorter wavelength portion of the spectrum to pass through. The optical filter 210C2 may be a high-pass optical filter, allowing the longer wavelength portion of the spectrum to pass through. The obtained spectrum is shown in FIG. 6B, in which the left half curve in FIG. 6B shows the transmittance graph of the short-wavelength spectrum obtained after passing through the beam splitter (or dichroic mirror) 230 and the optical filter 210C1, and the right half curve in FIG. 6B shows the transmittance graph of the long-wavelength spectrum obtained after passing through the beam splitter (or dichroic mirror) 230 and the optical filter 210C2. Therefore, in the embodiment, the filtered signal group may include a portion of the spectrum with longer wavelengths (long-wavelength band) and a portion of the spectrum with shorter wavelengths (short-wavelength band). In some embodiments, the beam splitter (or dichroic mirror) 230 combined with the optical filters 210C1 and 210C2 may be any combination of two types among high-pass optical filters, low-pass optical filters, or band-pass optical filters to form different wavelength bands with varying transmittance in the two light sensors.

As shown in FIGS. 4A to 4B, FIG. 5, and FIGS. 6A to 6B, the optical filter set 210 and the at least one light sensor 220 of the measurement module 200 in the spectrum measurement device 100 in FIG. 1A may have various forms, which may be adjusted according to requirements.

Referring to FIG. 1A again, the second part L22 of the spectrum to be measured L2 is reflected by the beam splitter 170 and is incident on the spectrometer 180. In the embodiment, the spectrometer 180 includes a reflector 180A, a grating 180B, and a light detector 180C, but the positions and quantities of the reflector 180A and the grating 180B may be adjusted or removed according to actual requirements, and the disclosure is not limited thereto. The spectrometer 180 may be used to measure the complete spectrum of the spectrum to be measured L2. Therefore, the second part L22 of the spectrum to be measured L2 may also be referred to as the monitor spectrum, because the spectral features obtained from the complete spectrum may be used to compare with the spectral features obtained by the algorithm to verify whether the spectral features obtained by the algorithm are reasonable.

The spectrum measurement device 100 shown in FIG. 1A may also be used as a measurement device for measuring reference spectra when establishing the algorithm. Since the measurement results of the spectrum to be measured L2 are used as reference spectra for establishing the algorithm, the spectrum to be measured L2 may also be referred to as a reference spectrum, and multiple filtered signal groups of the spectrum to be measured L2 may also be referred to as reference filtered signal groups of the reference spectrum. By measuring the complete spectrum of the second part L22 of the spectrum to be measured L2 with the spectrometer 180, the complete spectrum of the spectrum to be measured L2, i.e., the reference spectrum, may be obtained. On the other hand, by measuring multiple filtered signal groups of the first part L21 of the spectrum to be measured L2 with the measurement module 200, the measurement module 200 may obtain multiple filtered signal groups to be measured of the spectrum to be measured L2, i.e., the reference filtered signal groups of the reference spectrum. The algorithm is established using the spectral features corresponding to the reference spectrum and the reference filtered signal groups of the reference spectrum.

In some embodiments, the beam splitter 170 may also be a lens, allowing the spectrum to be measured L2 to be directly incident on the measurement module 200, omitting the spectrometer 180.

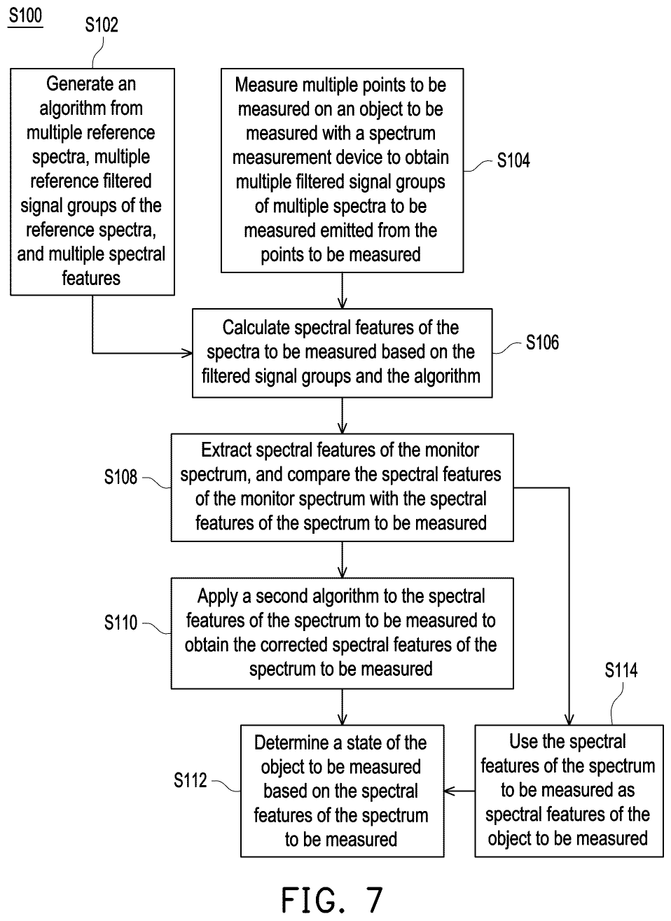

FIG. 7 is a flow chart of a spectral feature measurement method according to an embodiment of the disclosure. As shown in FIG. 7, a spectral feature measurement method S100 includes the following steps.

In step S102, an algorithm is generated from multiple reference spectra, multiple reference filtered signal groups of the reference spectra, and multiple spectral features, in which the similarity between the reference spectra and multiple spectra to be measured is greater than a similarity threshold. In other words, spectra with high spectrum similarity or low spectrum dissimilarity (SpD) to the spectra to be measured need to be used as the reference spectra.

Therefore, step S102 is divided into two parts: appropriate reference spectra are used, and the conversion relationship between the reference spectral features of the reference spectra and the reference filtered signal groups of the reference spectra is established, i.e., the algorithm.

In some embodiments, the reference spectra may be spectra generated by other identical objects to be measured, for example, spectra obtained from several previous objects to be measured in the same batch or with the same design. Since the objects to be measured are from the same process or design, when the process yield is sufficiently high, each of the objects to be measured should have highly similar spectra. Therefore, the spectra of the first few objects to be measured in the same process may be used as multiple reference spectra. The reference filtered signal groups corresponding to the spectra of the first few objects to be measured may be obtained using the spectrum measurement device.

In some embodiments, the reference spectra may be spectra generated from several reference points in the object to be measured. In the same semiconductor process, points in the same object to be measured should possess highly similar features. Therefore, spectra generated from multiple reference points selected on the same object to be measured may be used to produce multiple reference spectra. The reference filtered signal groups corresponding to the spectra of multiple reference points may be obtained using the spectrum measurement device.

In some embodiments, the reference spectra may be first reference spectra generated from at least one reference point in the object to be measured, and the first reference spectra may be shifted based on the peak wavelength of the first reference spectra, for example, by increasing or decreasing the peak wavelength by several nanometers to achieve the effect of shifted spectra. Multiple reference spectra may be generated through this method. The measurement module 200 of the spectrum measurement device, i.e., the response of the optical filter set 210 and the light sensor 220 to the reference spectra, may be simulated using the experimentally measured spectral response curves of the optical filter set 210 and the light sensor 220 to obtain the corresponding reference filtered signal groups.

In some embodiments, the algorithm may come from a database, using the established relationship between reference spectra and corresponding reference filtered signal groups of samples similar to the object to be measured. Therefore, it may not be needed to re-measure the spectrum or re-establish the algorithm.

Next, an algorithm is established. The algorithm includes the relationship between the spectral features of the reference spectra and the reference filtered signal groups in the reference spectra. The spectral features of the reference spectra may be obtained from the reference spectra.

In some embodiments, the algorithm may be a fitting function of the reference spectral features of the reference spectra to the reference filtered signal groups. The following description describes this method.

Suppose Xⁿᵢ represents the spectral features from the spectrum measured by the spectrometer, where Xⁿ may be spectral features, the superscript n represents different feature values, such as a peak wavelength (X¹), a dominant wavelength (X²), total spectral intensity (or spectral intensity) (X³), full width at half maximum (X⁴), color purity (X⁵) or chromaticity coordinates (X⁶,X⁷). The subscript i represents the i-th point, or the spectral features corresponding to the i-th element obtained by averaging several points. Rᵢ, Gᵢ, Bᵢ are the filtered signal group from the light detector, for example, the red light signal, green light signal, and blue light signal output by the light detector. The fitting rule is to find a fitting function fn such that Xⁿ=fn(R,G,B). The fitting function fn( ) may be a linear function, bilinear or bivariate polynomial function, or trivariate high-order function, but is not limited thereto. In some embodiments, the fitting function may not need to use all the filtered signals in the filtered signal group, which means that in the embodiment, the fitting function may merely use any two of Rᵢ, Gᵢ, Bᵢ.

Therefore, given a filtered signal group, the spectral features corresponding to the filtered signal group may be obtained through the fitting function.

In some embodiments, the algorithm may perform mathematical operations on the reference filtered signal group to obtain multiple representative parameters, and then apply machine learning algorithms such as clustering, regression analysis, or deep learning methods to the representative parameters to obtain the reference spectral features. The following description describes this method.

Mathematical operations are performed on the reference filtered signal group Rᵢ, Gᵢ, Bᵢ to obtain new representative parameters pⁿᵢqⁿᵢ. In the above expression, pⁿ=fⁿ2(R,G,B) and qⁿ==fⁿ3(R,G,B), where fⁿ2( ) and fⁿ3( ) are functions respectively corresponding to different representative parameters, and R, G, B are the R, G, B signals (i.e., the filtered signal group) output by the light sensor.

In other words, pⁿ and qⁿ are new representative parameters obtained by mathematical operations and transformations of the filtered signal group, that is, parameters obtained or dimensionally reduced by feature extraction methods such as Principal Component Analysis (PCA) or Linear Discriminant Analysis (LDA). After obtaining the representative parameters, the relationship between the representative parameters and spectral features may be established according to different requirements.

In some embodiments, machine learning clustering methods may be used to establish the relationship between representative parameters and spectral features. The specific approach is as follows.

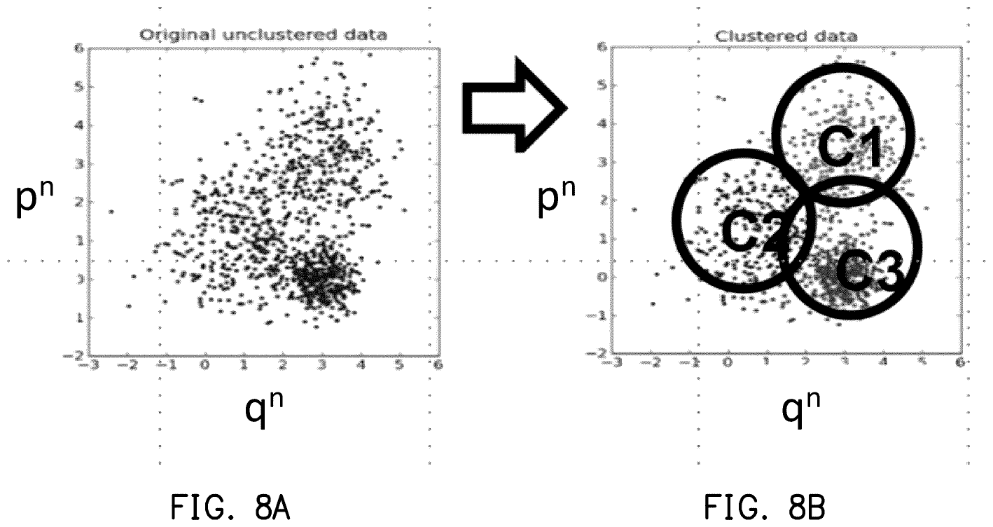

FIGS. 8A and 8B are clustering diagrams of a machine learning method according to an embodiment of the disclosure. First, a plot is made with the representative parameters pⁿ and qⁿ, as shown in FIG. 8A. Then, using machine learning methods such as k-means or Gaussian mixture model (GMM), the data is clustered into several groups such as C1, C2, C3, as shown in FIG. 8B. Within the same group, the reference spectra possess similar spectral features (for example: a peak wavelength, a dominant wavelength, total spectral intensity, full width at half maximum, color purity or chromaticity coordinates).

Therefore, for a specific group Cj, corresponding spectral features thereof may be the average of the spectral feature values within the group Cj, or the center of the group Cj, or the average of multiple points within the central region of the group Cj, to serve as the spectral features of the group Cj.

In some embodiments, machine learning regression analysis methods may be used to establish the relationship between representative parameters and spectral features Xⁿ=Fn(pⁿ,qⁿ). The specific approach is as follows.

Regression is performed on the spectral features Xⁿ using the representative parameters pⁿ and qⁿ to obtain the relationship Xⁿ=Fn(pⁿ,qⁿ). The regression model Fn(pⁿ,qⁿ) may be polynomial regression or multivariate regression, but the disclosure is not limited thereto.

In some embodiments, deep learning neural network architectures may be used to establish the relationship between representative parameters and spectral features. The specific approach is as follows.

For the representative parameters, deep learning neural network architectures may be used, including but not limited to Multilayer Perceptron (MLP), Deep Neural Network (DNN), Recurrent Neural Network (RNN), and Convolutional Neural Network (CNN), to conduct numerical analysis, in order to obtain the relationship between representative parameters and spectral features, thereby improving data resolution, prediction performance, and model accuracy.

After establishing the algorithm for spectral features and filtered signal group using the reference spectrum through the aforementioned methods, the process enters step S104.

In step S104, the spectrum measurement device 100 is used to measure multiple points to be measured on the object to be measured 110, to obtain multiple filtered signal groups of multiple spectra to be measured emitted from the points to be measured. In the step, the spectra to be measured emitted from the points to be measured may be electroluminescence or photoluminescence. In some embodiments, each of the filtered signal groups includes at least two filtered signals. As shown in FIGS. 4A to 4B, the filtered signal group includes three filtering information (Ri, Gi, Bi). In FIG. 5, the filtering information group includes three filtering information (Ri, Gi, Bi). In FIGS. 6A to 6B, the filtered signal group includes filtered spectra of different bands. The process enters step S106.

In step S106, based on the filtered signal groups and an algorithm, the spectral features of the spectra to be measured are calculated. The algorithm has been determined in step S102. In some embodiments, the spectral features include: a peak wavelength, a dominant wavelength, total spectral intensity, full width at half maximum, color purity, or chromaticity coordinates, but are not limited thereto. The process enters step S108.

In step S108, the spectral features of the monitor spectrum of at least one point of the object to be measured 110 are extracted. The monitor spectrum is measured by the spectrometer 180 in the spectrum measurement device 100. The spectral features of the monitor spectrum are compared with the spectral features of the spectrum to be measured obtained in step S106. In the comparison, the monitor spectrum and the spectrum to be measured are from the same point. Therefore, if the difference between the spectral features of the spectrum to be measured and the spectral features of the monitor spectrum, or the ratio of the difference to the spectral features of the monitor spectrum is less than a threshold, the process enters step S114. If the difference between the spectral features of the spectrum to be measured and the spectral features of the monitor spectrum, or the ratio of the difference to the spectral features of the monitor spectrum is greater than a threshold, the process enters step S110.

In step S114, if the difference between the spectral features of the spectrum to be measured and the spectral features of the monitor spectrum, or the ratio of the difference to the spectral features of the monitor spectrum is less than a threshold, this indicates that the spectral features of the spectrum to be measured calculated in step S106 meet the expectations. Therefore, the spectral features of the spectrum to be measured from S106 are used as the spectral features of the object to be measured, and the process enters step S112.

In step S110, a second algorithm is applied to the spectral features of the spectrum to be measured to obtain the corrected spectral features of the spectrum to be measured. The corrected spectral features of the spectrum to be measured are then used as the spectral features of the object to be measured. The second algorithm is established using the spectral features of the spectrum to be measured and the spectral features of the monitor spectrum. The specific approach is as follows.

If the difference between the spectral features of the spectrum to be measured and the spectral features of the monitor spectrum, or the ratio of the difference to the spectral features of the monitor spectrum is greater than a threshold, it indicates that the spectral features of the spectrum to be measured calculated in step S106 do not meet the expectations. The second algorithm may be established based on the relationship between the difference of the spectral features of the multi-point spectra to be measured and the spectral features of the monitor spectrum, or the ratio of the difference to the spectral features of the monitor spectrum, and the spectral features of the spectrum to be measured.

In some embodiments, for example, when the difference between the spectral features of the spectrum to be measured and the spectral features of the monitor spectrum, or the ratio of the difference to the spectral features of the monitor spectrum is a constant value, a constant may be introduced to correct the spectral features of the spectrum to be measured obtained in step S106, so that the difference between the corrected spectral features of the spectrum to be measured and the spectral features of the monitor spectrum is less than the threshold. Therefore, in some embodiments, the second algorithm in step S110 is to add a constant to the spectral features of the spectrum to be measured to obtain the corrected spectral features of the spectrum to be measured, so that the difference between the corrected spectral features of the spectrum to be measured and the spectral features of the monitor spectrum is less than the threshold, and then the process enters step S112.

Or in some embodiments, when there exists a mathematical relationship, such as a linear relationship, between the difference of the spectral features of the spectrum to be measured and the spectral features of the monitor spectrum, or the ratio of the difference to the spectral features of the monitor spectrum, and the spectral features of the spectrum to be measured, the second algorithm in step S110 may be to add the mathematical relationship correction to the spectral features of the spectrum to be measured, so that the difference between the corrected spectral features of the spectrum to be measured and the spectral features of the monitor spectrum is less than the threshold, and then the process enters step S112.

In step S112, the state of the object to be measured is determined based on the corrected spectral features of the spectrum to be measured or the spectral features of the spectrum to be measured. If the corrected spectral features of the spectrum to be measured or the spectral features of the spectrum to be measured are less than a state threshold, the state of the point to be measured may be determined. The state may include: normal, abnormal, or meeting standards, but is not limited thereto.

In another embodiment, in the spectral feature measurement method S100 shown in FIG. 7, step S112 may be omitted. That is, the spectral feature measurement method S100 ends with measuring and obtaining the corrected spectral features of the spectrum to be measured or the spectral features of the spectrum to be measured, without determining the state of the object to be measured.

In another embodiment, in the spectral feature measurement method S100 as shown in FIG. 7, steps S108 and S110 may be omitted. That is, in a design or process that is sufficiently reliable or mature, or when the spectral features allow for larger measurement errors or are relatively less strict, the steps of monitor spectrum measurement may be omitted.

In another embodiment, a flow chart similar to FIG. 7 may also be used to identify the defect type on the object to be measured. In semiconductor processes, especially in compound semiconductors, various types of defects are generated in the substrate, epitaxial layer, or component processes. Different types of defects possess different spectra, but similar types of defects often have similar spectra.

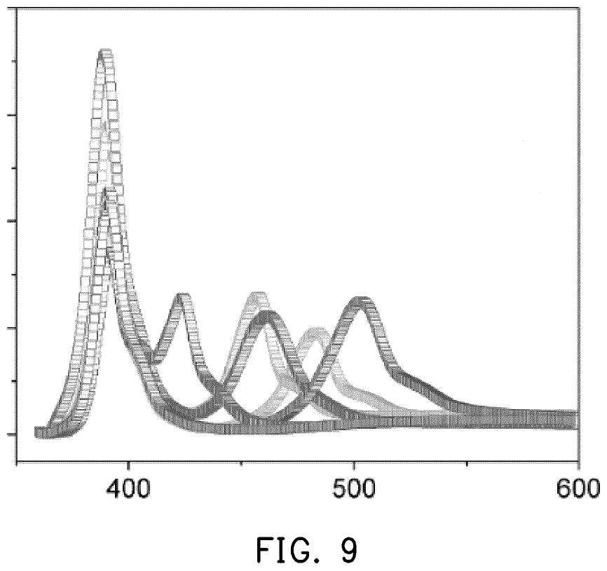

FIG. 9 is a schematic diagram of spectra of defect images of an object to be measured according to an embodiment of the disclosure. As shown in FIG. 9, in the object to be measured, different types of defects possess different spectra, but similar types of defects often have similar spectra.

Therefore, by means of the spectral features corresponding to the defects, it may be used to determine which type of defect corresponds to the defect on the object to be measured. Determining the type of defect using spectral features helps to timely discover problems in the process, thereby improving product yield or providing feedback for process parameters.

The following describes how to determine the type of defect using a spectral feature measurement method similar to the spectral feature measurement method shown in FIG. 7.

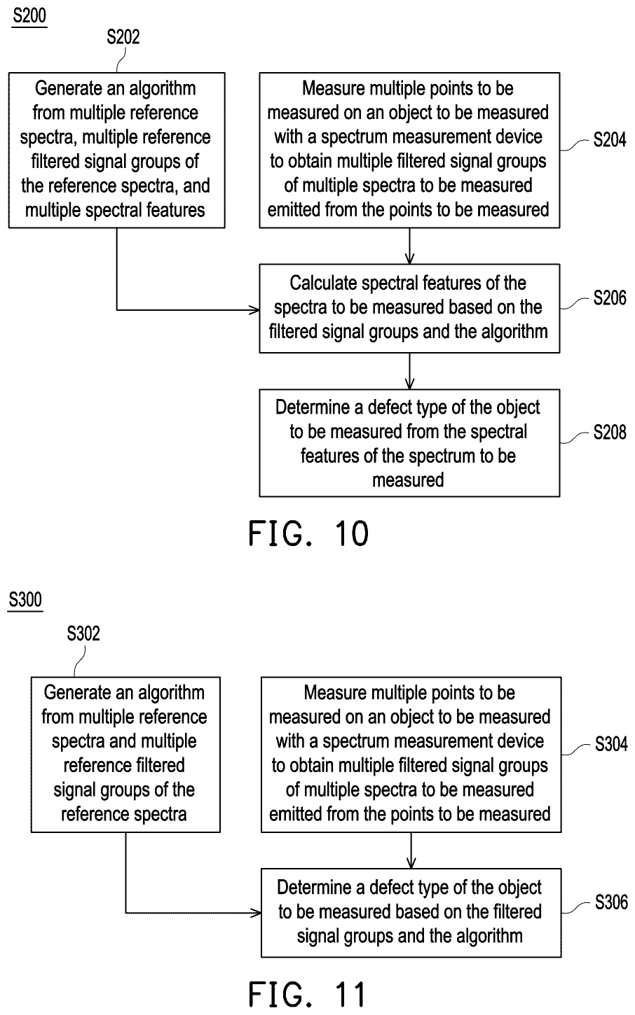

FIG. 10 is a flow chart of another spectral feature measurement method according to an embodiment of the disclosure. As shown in FIG. 10, a spectral feature measurement method S200 includes the following steps.

In step S202, an algorithm is generated from multiple reference spectra, multiple reference filtered signal groups of the reference spectra, and multiple spectral features, in which the similarity between the reference spectra and the spectra to be measured is greater than a similarity threshold. The step is similar to step S102 in FIG. 7, so similar aspects are not repeated. The difference from step S102 is that the reference spectra used in step S202 are spectra generated from various types of defects.

In step S204, the spectrum measurement device 100 is used to measure multiple points to be measured on the object to be measured 110 to obtain multiple filtered signal groups of multiple spectra to be measured emitted from the points to be measured. The step is similar to step S104 in FIG. 7, so the step is not repeated. The process enters step S206.

In step S206, the spectral features of the spectra to be measured are calculated based on the filtered signal groups and an algorithm. In some embodiments, the spectral features include: a peak wavelength, a dominant wavelength, total spectral intensity, full width at half maximum, color purity, or chromaticity coordinates, but are not limited thereto. The step is similar to step S106 in FIG. 7, so the step is not repeated. The process enters step S208.

In step S208, the defect type of the object to be measured is determined from the spectral features of the spectrum to be measured. Specifically, the spectral features of the spectrum to be measured are compared with the spectral features of known defect types, and the defect type of the object to be measured is determined to correspond to which type of known defect type based on the degree of similarity with the spectral features of known defect types. For example, the spectral features of known defect types, such as the position of a spectral peak, may be used for comparison to determine which type of known defect type corresponds to the defect type of the object to be measured.

By this method, defect types can be quickly identified even when merely partial spectra of the object to be measured are collected.

FIG. 11 is a flow chart of another spectral feature measurement method according to an embodiment of the disclosure. As shown in FIG. 11, a spectral feature measurement method S300 includes the following steps.

In step S302, an algorithm is generated from multiple reference spectra produced by multiple defect types and multiple reference filtered signal groups of the reference spectra, to establish the relationship between defect types and multiple reference filtered signal groups. In other words, it is not needed to calculate spectral features, but the corresponding defect type may be obtained directly from the filtered signal group.

The algorithm includes: corresponding multiple representative parameters are obtained from multiple filtered signal groups and a mathematical operation, and corresponding types are obtained by clustering the established representative parameters. The method of obtaining representative parameters is described in FIG. 8A and corresponding paragraphs, to calculate the representative parameters pⁿ and qⁿ and plot the representative parameters pⁿ and qⁿ, as shown in FIG. 8A. Then, as described in FIG. 8B and corresponding paragraphs, for example, using machine learning methods such as k-means or Gaussian mixture model (GMM), the data is clustered into several groups such as C1, C2, C3, as shown in FIG. 8B. Here, the same group represents the same defect type.

In step S304, the spectrum measurement device 100 is used to measure multiple points to be measured on the object to be measured 110 to obtain multiple filtered signal groups of multiple spectra to be measured emitted from the points to be measured. The step is similar to step S204 in FIG. 10. The difference is that the points to be measured are the positions of points to be measured with defects. The process enters step S306.

In step S306, the defect type of the object to be measured is determined based on the filtered signal groups and the algorithm. Specifically, based on the filtered signals of the spectrum to be measured, the defect type of the object to be measured may be directly determined using the algorithm obtained in step S302.

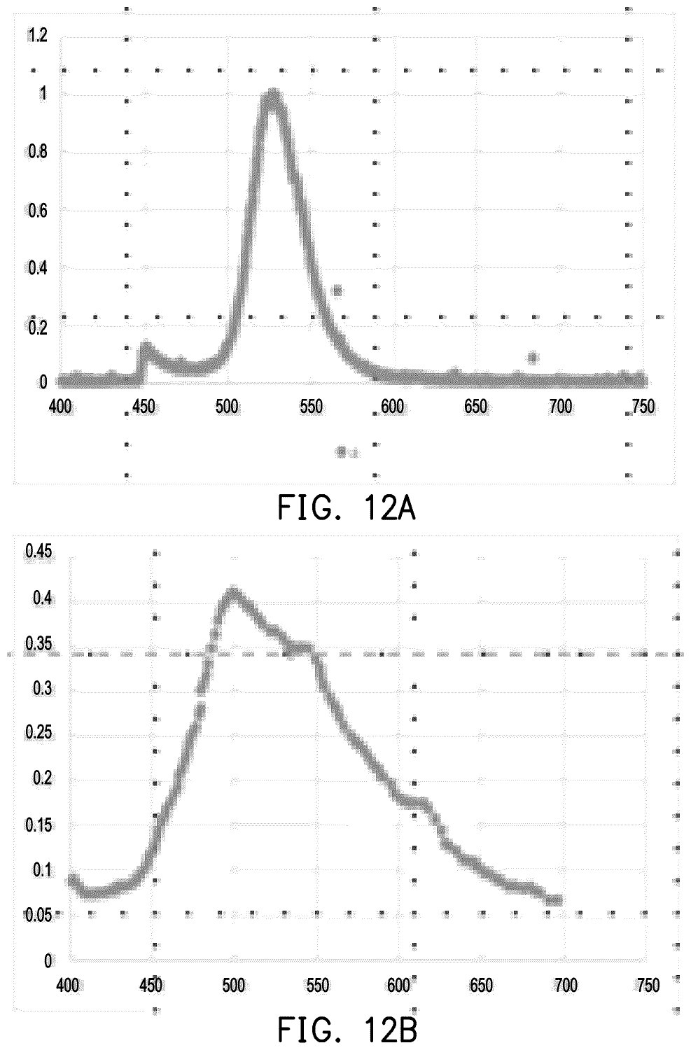

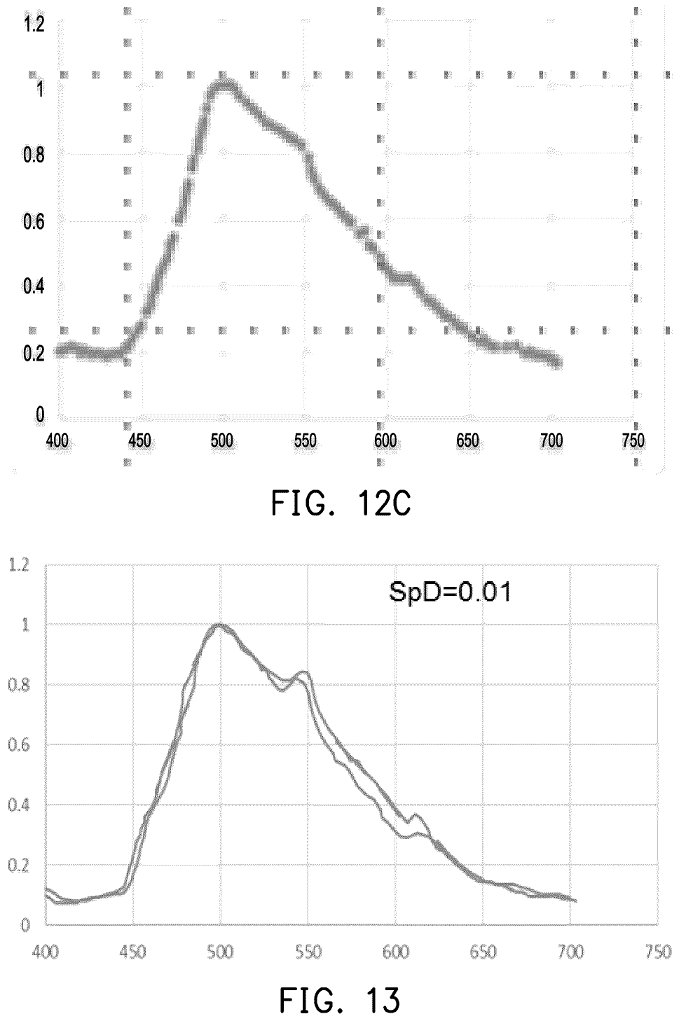

FIGS. 12A to 12C are schematic diagrams of spectra of defects on the object to be measured according to an embodiment of the disclosure. As shown in FIGS. 12A to 12C, FIGS. 12A to 12C respectively correspond to spectra of three different appearance defects. It can be seen that the spectrum corresponding to FIG. 12A is quite different from the spectra corresponding to FIG. 12B and FIG. 12C. Although FIG. 12B and FIG. 12C have different appearances, corresponding spectra thereof are quite similar and may be classified as the same type of defect. Therefore, from the spectra, it can be seen that FIG. 12A to FIG. 12C correspond to two different types of defects, in which FIG. 12A corresponds to one type of defect, and FIG. 12B and FIG. 12C correspond to another type of defect.

FIG. 13 is a schematic diagram of spectrum dissimilarity of defect images of the object to be measured according to an embodiment of the disclosure. Referring to FIG. 13, to make the spectra of FIG. 12B and FIG. 12C easier to compare, in FIG. 13, the spectra of FIG. 12B and FIG. 12C are normalized and overlapped for comparison, and spectrum dissimilarity (SpD) thereof is calculated. As shown in FIG. 13, the spectrum dissimilarity of the two spectra is 0.01, so it may be determined that the two spectra are the same defect type and also possess similar spectral features. The defect type may be determined from the spectral features or from the filtered signal group.

In summary, the rapid spectral feature measurement method provided by the disclosure uses a camera with an optical filter set to quickly measure multi-point spectra on a wafer, combined with a process and correction technique, balancing accuracy and speed. Moreover, spectral features may be obtained without fully scanning the spectrum, which may effectively reduce detection costs and improve detection efficiency.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A spectral feature measurement method, comprising:
measuring a plurality of points to be measured on an object to be measured with a spectrum measurement device to obtain a plurality of filtered signal groups of a plurality of spectra to be measured emitted from the plurality of points to be measured; and
calculating spectral features of the plurality of spectra to be measured based on the plurality of filtered signal groups and an algorithm;
wherein the algorithm is generated from a plurality of reference spectra, a plurality of reference filtered signal groups of the plurality of reference spectra, and the plurality of spectral features, and similarity between the plurality of reference spectra and the plurality of spectra to be measured is greater than a similarity threshold.

2. The spectral feature measurement method according to claim 1, wherein each of the plurality of filtered signal groups comprises at least two filtered signals.

3. The spectral feature measurement method according to claim 1, wherein the spectrum measurement device comprises an optical filter set and at least one light sensor, wherein the plurality of spectra to be measured emitted from the plurality of points to be measured are incident on the at least one light sensor through the optical filter set, and the plurality of filtered signal groups are obtained after detection by the at least one light sensor.

4. The spectral feature measurement method according to claim 1, further comprising:
determining a state of the plurality of points to be measured based on the spectral features.

5. The spectral feature measurement method according to claim 4, wherein the state of the object to be measured comprises normal, abnormal, or meeting standards.

6. The spectral feature measurement method according to claim 1, wherein the plurality of reference spectra are spectra generated by other identical objects to be measured.

7. The spectral feature measurement method according to claim 1, wherein the plurality of reference spectra are spectra generated by several reference points in the object to be measured.

8. The spectral feature measurement method according to claim 1, wherein the plurality of reference spectra comprises a first reference spectrum generated by at least one reference point in the object to be measured, and the first reference spectrum is shifted based on a peak wavelength of the first reference spectrum.

9. The spectral feature measurement method according to claim 1, wherein the algorithm is based on a relationship between established reference spectra and corresponding reference filtered signal groups of samples similar to the object to be measured from a database.

10. The spectral feature measurement method according to claim 1, wherein the algorithm is a fitting function of the reference spectral features of reference to the reference filtered signal groups.

11. The spectral feature measurement method according to claim 1, wherein the algorithm performs mathematical operations on the reference filtered signal groups to obtain a plurality of representative parameters, and applies machine learning algorithms such as clustering, regression analysis, or deep learning methods to the plurality of representative parameters and the reference spectral features to obtain a corresponding relationship.

12. The spectral feature measurement method according to claim 1, wherein the spectral features comprise: a peak wavelength, a dominant wavelength, total spectral intensity, full width at half maximum, color purity or chromaticity coordinates.

13. The spectral feature measurement method according to claim 1, wherein the plurality of points to be measured emit the plurality of spectra to be measured by electroluminescence or photoluminescence,
wherein the electroluminescence is the radiation by applying electricity to the point to be measured,
wherein the photoluminescence is the radiation by irradiating the point to be measured with an excitation beam to excite the point to be measured and cause the point to be measured to emit light.

14. The spectral feature measurement method according to claim 1, wherein the spectrum measurement device further comprises a spectrometer, and the spectral feature measurement method further comprises: measuring a monitor spectrum of at least one point of the object to be measured using the spectrometer, and extracting spectral features of the monitor spectrum.

15. The spectral feature measurement method according to claim 14, further comprising: if a difference between the spectral features of the spectrum to be measured and the spectral features of the monitor spectrum, or a ratio of the difference to the spectral features of the monitor spectrum is less than a threshold, using the spectral features of the spectrum to be measured as spectral features of the object to be measured.

16. The spectral feature measurement method according to claim 14, further comprising: if the difference between the spectral features of the spectrum to be measured and the spectral features of the monitor spectrum, or the ratio of the difference to the spectral features of the monitor spectrum is greater than a threshold, performing a second algorithm on the spectral features of the spectrum to be measured to obtain corrected spectral features of the spectrum to be measured, and using the corrected spectral features of the spectrum to be measured as the spectral features of the object to be measured.

17. The spectral feature measurement method according to claim 1, wherein the spectrum measurement device further comprises a spectrometer, and the spectral feature measurement method further comprises: measuring a spectrum of at least one point of the object to be measured using the spectrometer to serve as the plurality of reference spectra.

18. The spectral feature measurement method according to claim 1, further comprising: determining a defect type of the object to be measured based on the spectral features.

19. A spectral feature measurement method, comprising:
measuring a plurality of points to be measured on an object to be measured with a spectrum measurement device to obtain a plurality of filtered signal groups of a plurality of spectra to be measured emitted from the plurality of points to be measured; and
determining a defect type of the object to be measured based on the plurality of filtered signal groups and an algorithm,
wherein the algorithm is generated by a plurality of reference spectra produced by a plurality of types of defects of the object to be measured, a plurality of reference filtered signal groups of the plurality of reference spectra, and the plurality of types of defects of the object to be measured.
